(19) United States
(12) Patent Application Publication
(10) Pub. No.: US 2006/0120688 A1
(43) Pub. Date: Jun. 8, 2006

(54) Electronic device including timer programmed recording means

(75) Inventor: Hitomi Uchida, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD.,, Echizen-city (JP)

(21) Appl. No.: 11/293,251

(22) Filed: Dec. 5, 2005

(30) Foreign Application Priority Data
Dec. 8, 2004 (JP) 2004-354963

(51) Int. Cl. H04N 5/91

(52) U.S. Cl. 386/83

(57) ABSTRACT

A recording and reproducing device, wherein, if preset programs are overlapping, a recording end process is performed at the end of a last preset recording program resolving the overlapping so as to decrease cases of missing the recording. A programmed recording overlapping detecting portion 63 for controlling programmed recording detects the overlapping and provides an overlapping flag, an overlapping number counting portion 64 counts the number of overlaps of a preset recording program 100 having the overlapping flag provided, a marking process portion 65 marks an overlapping position to have it stored by a second memory portion 70, and a recording execution control portion 67 determines the marked position T as a starting position of the follow-on preset recording program 100 and performs a recording end process 108 at an ending time 102 of the last preset recording program 100 so as to switch the preset recording program instantaneously.

The present application is based on and claims priority of Japanese patent application No. 2004-354963 filed on Dec. 8, 2004, the entire contents of which are hereby incorporated by reference.

### BACKGROUND OF THE INVENTION

1. Field of the Invention

The present invention relates to an electronic device such as a recording device or a recording and reproducing device capable of performing programmed recording of multiple programs or an electronic device such as a television set having a built-in DVD device with a recording function, and in particular, to an electronic device including timer programmed recording means capable of decreasing the cases of missing the recording even when preset recording programs are overlapping.

2. Description of the Related Art

Conventionally, it is a general practice, for a recording device or a recording and reproducing device capable of performing programmed recording of multiple programs, to perform a recording end process for each recorded program immediately after finishing the recording when executing set-up recording of preset recording programs. For instance, in the case of setting a first program for starting recording earlier and a follow-on second program in setting up the programmed recording, portions of the first program and the second program may overlap to set a starting time of the second program within recording time of the first program. Otherwise, in the case where a recording starting time 101 of the second program is simultaneous with a recording ending time 102 of the first program as shown in FIG. 10, the recording of the second program is started after finishing the first program and then performing a recording end process 108 of the first program. Therefore, the recording of the second program is started after the time required for the recording end process 108 of the first program elapses as against its original recording starting time 101. Thus, the time required for the recording end process 108 of the first program becomes an unrecordable portion and becomes an unrecordable portion 106 of the follow-on second program. Therefore, as shown in FIG. 10, it is not possible, as the time of the recording end process portion 108 is overlapping, to record two preset recording programs 100 to be simultaneously switched which is smoothly switchable at a glance.

As for a method of preventing a lack of the preset recording program occurring on performing the programmed recording of multiple programs, Japanese Patent Laid-Open Publication No. 2003-157596 (patent document 1) for instance discloses as a conventional technique the method of, in the case where the recording time of multiple preset programs is partially overlapping, marking off the overlapping time at an arbitrary time point and setting this time point as the recording ending time of a preceding program starting earlier and also setting this time point as the recording starting time of a follow-on program starting later out of the overlapping preset recording programs.

According to the conventional technique, the recording end process is performed at the end of each individual preset recording program 100 when performing the programmed recording. During approximately 10 to 20 seconds required for the recording end process portion 108, the start of recording of the second program is delayed so that the beginning of the second program is lost. The recording end process portion 108 is essential as work for organizing and saving recording data on a recording medium, and so the recording of the follow-on second program cannot be started during the time of the recording end process portion 108. Therefore, if the second program following the preceding first program is a PPV (Pay Per View) which is a pay-broadcast for instance, the second program as the PPV cannot be started if the starting time of the programmed recording is delayed just by 10 to 20 seconds from a preset time.

### SUMMARY OF THE INVENTION

The present invention has been made in view of the problems, and obtains an electronic device including timer programmed recording means capable of, even if there is a portion of overlapping recording time on performing multiple programmed recordings on a DVD recording device or a DVD recording and reproducing device in particular, starting recording by promptly switching to a follow-on new program, resolving the cases of missing the recording of the new program due to a recording end process before the switching and allowing a recording channel to be smoothly switched without interruption of the recording so as to reduce discomfort of a user.

An electronic device including timer programmed recording means for performing recording on a recording medium according to a first aspect is the one comprising: a tuner for converting a receiving signal of a television broadcast to a video and audio signal; a video and audio processing portion for converting the video and audio signal to a recordable digital video and audio signal; a microcomputer portion for controlling the video and audio processing portion and also controlling a timer programmed recording operation; a first memory portion in the microcomputer portion for storing a preset recording program information of the microcomputer portion; a second memory portion for storing control information on the preset recording program, and the recording medium for recording and making a record of the digital video and audio signal, and further comprising: a remote control for transmitting an instruction of a user to the microcomputer portion; and a remote control light receiving portion for light-receiving an instruction signal inputted by a key operation of the remote control, and wherein: the microcomputer portion includes:

a key input processing portion for processing the instruction signal light-received from the remote control; a presetting portion for setting a key-inputted preset recording program; a programmed recording overlapping detecting portion for detecting and determining whether or not recording time is overlapping as to multiple preset recording programs and providing an overlapping flag; an overlapping number counting portion for counting the number of overlapping portions of the preset recording program; a time keeping portion, including a clock circuit, for monitoring a current time and at least a recording starting time, a recording ending time, an overlapping starting time and an overlapping ending time of the preset recording program; a marking process portion for marking a switching time of the overlapping preset recording program correspondingly to the overlapping flag; and a recording execution control portion for storing the preset recording program in the first memory portion in the microcomputer portion, storing the overlapping flag, the number of overlaps and the marking as the control information on the preset recording program in the second memory portion, and exerting execution control of the preset recording program based on time information of the timekeeping portion, and the recording execution control portion exerts control so as to perform no recording end process of the preset recording program at the end of the preset recording program preceding in recording among the overlapping preset recording programs, start recording by successively switching to the follow-on preset recording programs at the marked position and perform the recording end process of the multiple overlapping preset recording programs at the end of recording of the last one of the follow-on overlapping preset recording programs.

According to a configuration of the first aspect, the electronic device including timer programmed recording means for performing recording on a recording medium comprises a tuner for converting a receiving signal of a television broadcast to a video and audio signal, a video and audio processing portion for converting the video and audio signal to a recordable digital video and audio signal, a microcomputer portion for controlling the video and audio processing portion and also controlling a timer programmed recording operation; a first memory portion in the microcomputer portion for storing a preset recording program of the microcomputer portion, a second memory portion for storing control information on the preset recording program, and the recording medium for recording and making a record of the digital video and audio signal, and further comprises a remote control for transmitting an instruction of a user to the microcomputer portion, and a remote control light receiving portion for light-receiving an instruction signal inputted by a key operation of the remote control. The microcomputer portion is provided therein with a key input processing portion which processes the instruction signal light-received from the remote control, a presetting portion which sets a key-inputted preset recording program, a programmed recording overlapping detecting portion which detects and determines whether or not recording time is overlapping as to multiple preset recording programs and provides an overlapping flag if there is one, and the overlapping number counting portion which counts the number of overlapping portions of the preset recording program to store it in the memory. The timekeeping portion including a clock circuit monitors a current time and at least a recording starting time, a recording ending time, an overlapping starting time and an overlapping ending time of the preset recording program, the marking process portion marks a switching time of the overlapping preset recording program, and the recording execution control portion stores the preset recording program in the first memory portion in the microcomputer portion, stores the overlapping flag, the number of overlaps and the marking as the control information on the preset recording program in the second memory portion and exerts execution control of the preset recording program based on time information of the timekeeping portion. Thus, even if the multiple preset recording programs come to overlap, the recording execution control portion can exert control to perform no recording end process of the preset recording program at the end of the preset recording program preceding in recording among the overlapping preset recording programs, start recording by successively switching to the follow-on preset recording programs at the marked position and perform the recording end process of the multiple overlapping preset recording programs at the end of recording of the last one of the follow-on overlapping preset recording programs. Therefore, it is possible to perform the recording end process required on switching the overlapping preset recording programs at the end of the recording of the follow-on preset recording programs or put it off so as to prevent the portion of the recording end process time from missing as from the recording starting time of the follow-on preset recording program. For this reason, even if there is a portion of overlapping recording time on performing multiple programmed recordings on an electronic device such as a DVD recording device, a DVD recording and reproducing device or a television set having them built-in, it is possible to start recording by promptly switching to a follow-on new program and resolve the cases of missing the recording due to the recording end process required on switching the programs.

The electronic device including timer programmed recording means according to a second aspect is the electronic device including timer programmed recording means according to the first aspect wherein the overlapping preset recording program includes overlapping recording time caused by adding the recording end process time to the time required for the preset recording program.

According to the configuration of the second aspect, the overlapping preset recording program has the recording time overlapped by adding the recording end process time to the time required for the preset recording program. Therefore, there is a problem that, even in the case where the recording ending time and recording starting time of the multiple preset recording programs successively switchable at a glance become simultaneous, it is conventionally necessary to perform the recording end process at the end of recording of each individual preset recording program so that a recording starting portion of the follow-on preset recording program becomes missing. It is possible, in this regard, to perform the recording end process collectively at the end of recording of the last preset recording program which is no longer overlapping instead of the end of the preset recording program having performed the recording end process earlier. Therefore, even if there is a portion of overlapping recording time on performing multiple programmed recordings on a DVD recording device or a DVD recording and reproducing device or a television set having them built-in, it is possible to start recording by promptly switching to a follow-on new program and thereby resolve the cases of missing the recording of the new program due to the recording end process before the switching and allow a recording channel to be smoothly switched without interruption of the recording so as to reduce discomfort of the user.

### BRIEF DESCRIPTION OF THE DRAWINGS

FIG. 1 is a block schematic diagram showing an overview configuration of timer programmed recording means of a television set having a built-in DVD recording and reproducing device showing a first embodiment of the present invention;

FIG. 2 is a schematic perspective view showing an appearance of the television set having the built-in DVD recording and reproducing device of the present invention;

FIG. 3 are time chart schematic diagrams showing a recording end process when preset recording programs are overlapping according to the present invention;

FIG. 4 are time chart schematic diagrams showing preset recording program examples according to the present invention;

FIG. 5 is a flowchart schematic diagram showing an operation on setting the timer programmed recording according to the present invention;

FIG. 6 is a flowchart schematic diagram showing the operation on setting the timer programmed recording according to the present invention;

FIG. 7 is a flowchart schematic diagram showing the operation in a process at the end of the timer programmed recording according to the present invention;

FIG. 8 is a flowchart schematic diagram showing the operation on setting the timer programmed recording showing a second embodiment of the present invention;

FIG. 9 is a flowchart schematic diagram showing the operation at the end of the timer programmed recording showing the second embodiment of the present invention; and

FIG. 10 is a time chart schematic diagram showing a recording end process of overlapping preset recording programs in a conventional timer programmed recording.

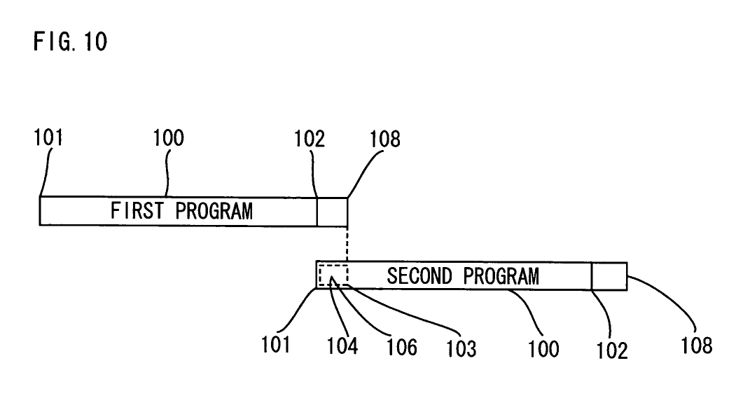

### DETAILED DESCRIPTION OF THE PREFERRED EMBODIMENTS

As described above, the present invention decreases the cases of missing recording due to overlaps of multiple preset recording programs on an electronic device such as a DVD device for performing programmed recording of television broadcast programs or an electronic device such as a television set having a built-in DVD device with a recording function. However, the following embodiments will describe the television set having a built-in DVD recording and reproducing device as electronic device.

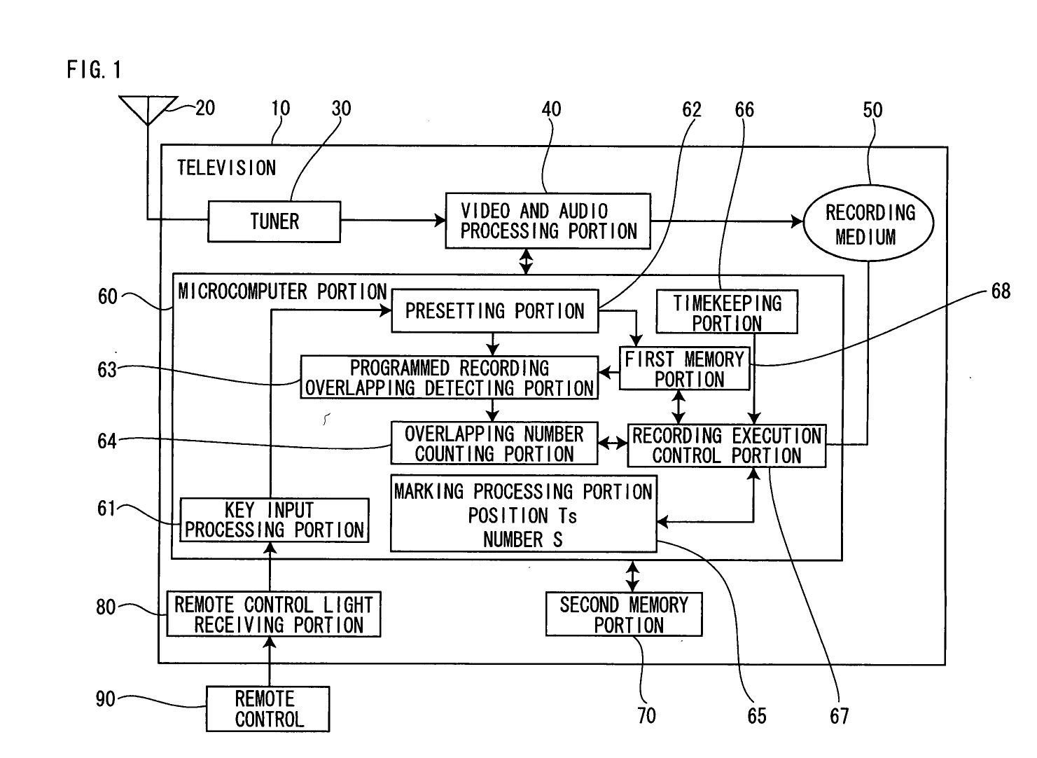

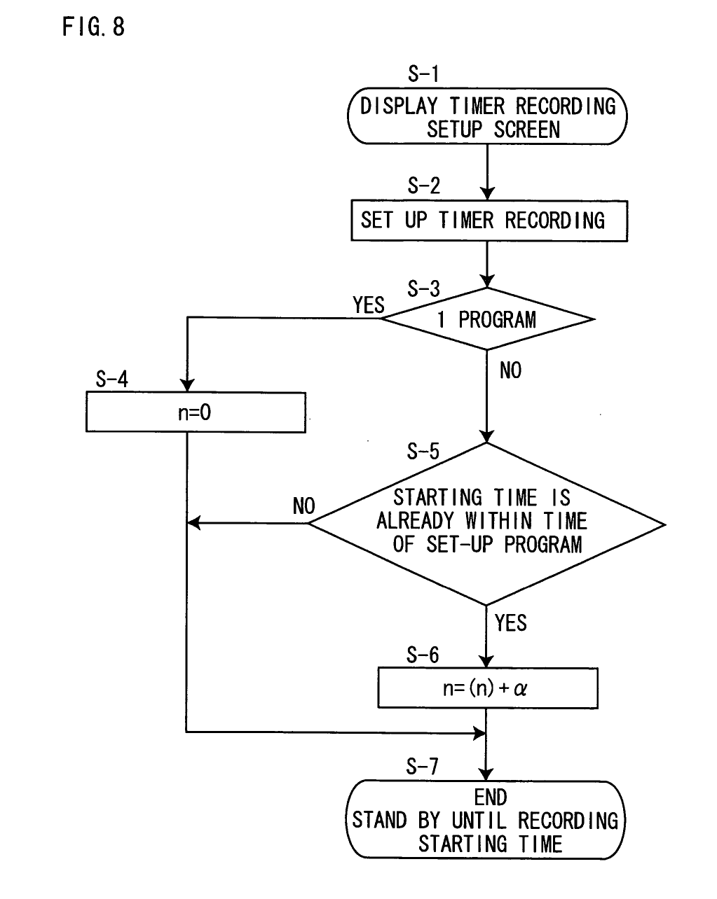

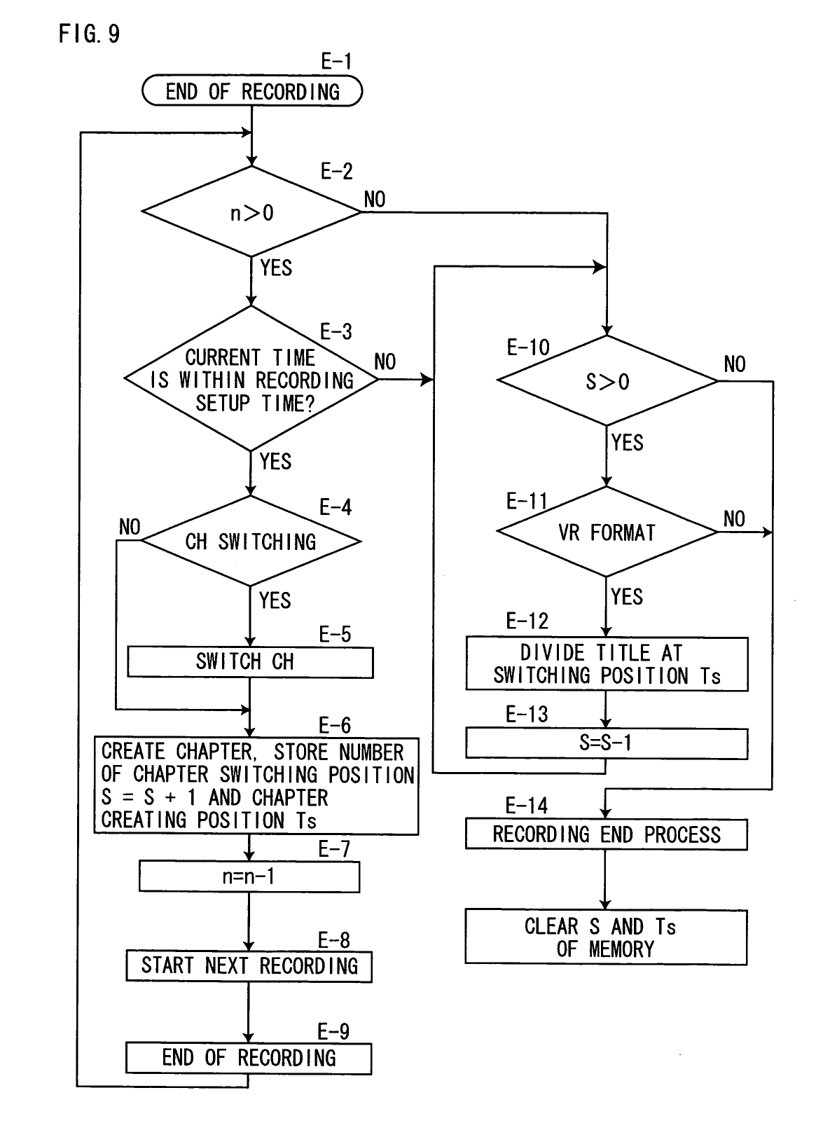

Hereunder, a description will be given by referring to FIGS. 1 to 9 as to the preferred embodiments for implementing the present invention. FIGS. 1 to 7 are schematic diagrams showing a first embodiment, and FIGS. 8 to 9 are schematic diagrams showing a second embodiment. It goes without saying that the present invention is also easily applicable to those other than the description of the embodiments to the extent of not going against the purposes of the invention.

### First Embodiment

FIG. 1 is a block diagram showing an overview configuration of timer programmed recording means of a television set having a built-in DVD recording and reproducing device showing a first embodiment of the present invention.

A television set 10 as the electronic device having a built-in DVD recording and reproducing device shown in FIG. 1 comprises a tuner 30 for converting a receiving signal of a television broadcast received by an antenna 20 to a video and audio signal, a video and audio processing portion 40 for converting the video and audio signal to a recordable digital video and audio signal, a microcomputer portion 60 for controlling the video and audio processing portion 40 and also controlling a timer programmed recording operation, a first memory portion 68 called an RAM (Random Access Memory) in the microcomputer portion 60 for storing a preset recording program of the microcomputer portion 60, a second memory portion 70 for storing control information on the preset recording program and a recording medium 50 for recording and making a record of the digital video and audio signal. It further comprises a remote control 90 for transmitting an instruction of a user to the microcomputer portion 60 to perform recording on the recording medium 50. The television set 10 having a built-in DVD recording and reproducing device comprises a remote control light receiving portion 80 for light-receiving an instruction signal inputted by a key operation of the remote control 90. The microcomputer portion 60 includes a key input processing portion 61 for processing the instruction signal light-received, a presetting portion 62 for setting the key-inputted preset recording program, a programmed recording overlapping detecting portion 63 for detecting whether or not recording time is overlapping as to multiple preset recording programs and determining it as an overlapping programmed recording if overlapping, an overlapping number counting portion 64 for counting the number of overlapping portions of the preset recording program, a timekeeping portion 66, including a clock circuit, for monitoring a current time and at least a recording starting time, a recording ending time and an overlapping recording time of the preset recording program, a marking process portion 65 for marking a switching time of the overlapping preset recording program and a recording execution control portion 67 for storing the preset recording program in the first memory portion (Random Access Memory) 68 in the microcomputer portion 60, storing the overlapping flag, the number of overlaps and the marking as the control information on the preset recording program in the second memory portion 70, and exerting execution control of the preset recording program based on time information of the timekeeping portion 66. The recording execution control portion 67 can exerts control so as to perform the recording end process of the overlapping preset recording program as one recording or perform no recording end process of the preceding preset recording program at the end of the preset recording program, start recording by successively switching to the follow-on preset recording programs at the marked position and perform the recording end process of the preceding preset recording program and the follow-on preset recording program at the end of recording of the follow-on overlapping preset recording programs.

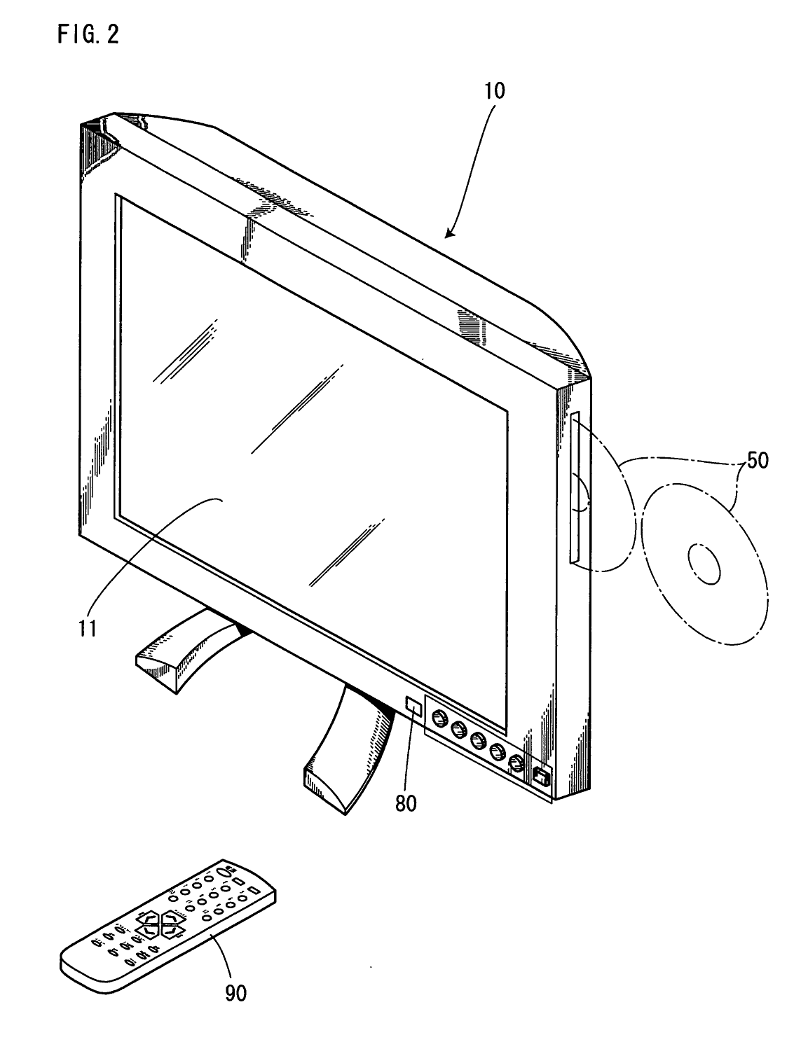

FIG. 2 is a schematic perspective view showing an appearance of the television set having a built-in DVD recording and reproducing device.

In FIG. 2, reference numeral 10 denotes the television set having a built-in DVD recording and reproducing device as the electronic device according to the present invention. A display portion 11 is placed at the center of FIG. 2, where it is indicated that a recording medium 50 is detachably stored on the right side. A remote control light receiving portion 80 is placed at the bottom of the front, and a remote control 90 is placed opposite it. The preset recording program indicated by the user with an unshown operation key of the remote control 90 is received by the remote control light receiving portion 80 so as to control an unshown DVD recording and reproducing device built into the television set 10 having the built-in DVD recording and reproducing device.

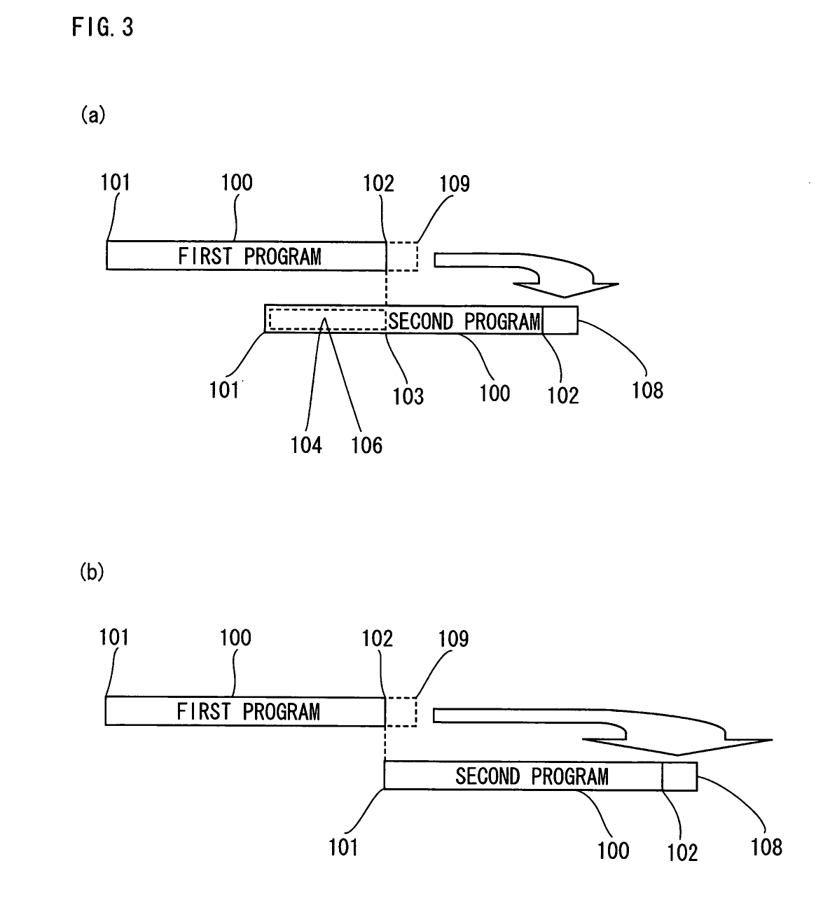

Next, FIG. 3 are time chart schematic diagrams for describing a method of, when two preset recording programs are overlapping, performing the recording end process collectively at the end of two overlapping preset recording programs instead of performing it at the end of the preceding preset recording program according to the present invention.

FIG. 3 (a) shows the case where the recording time is overlapping. In this case, control is exerted by the recording execution control portion 67 shown in FIG. 1 to perform a recording end process 108 as one recording of the first and second programs having overlapping preset recording program 100 or perform no recording end process of the first program at a recording ending time 102 of the preceding first program, start recording of the second program by successively switching to the follow-on second program from an actual recording starting time 103 delayed from a set-up recording starting time 101 just by a program overlapping portion 104 and perform the recording end process 108 of the preceding first program and the follow-on second program at the ending time 102 of the follow-on second program. Therefore, a dashed portion 109 following the recording ending time 102 of the first program is a portion for performing no recording end process or a putting it off. FIG. 3 (b) shows the case where the recording ending time 102 of the first program and the recording starting time 101 of the second program are the same time. As the recording starting time 101 of the second program is delayed by performing the recording end process of the first program, control is exerted by the recording execution control portion 67 shown in FIG. 1 to perform the recording end process 108 as one recording of first and second programs or start the recording of the second program from the set-up recording starting time 101 by successively switching to the follow-on second program from the recording ending time 102 of the preceding first program so as to perform the recording end process 108 of the preceding first program and the follow-on second program from the ending time 102 of the second program. Therefore, the recording end process portion of the first program indicated in the dashed line is a portion 109 for performing no recording end process or a putting it off. In the case of switching from the first program to the second program at the same time, the programmed recording overlapping detecting portion 63 shown in FIG. 1 is controlled to count the time required for the recording end process as the overlapping portion as with the program overlapping portion.

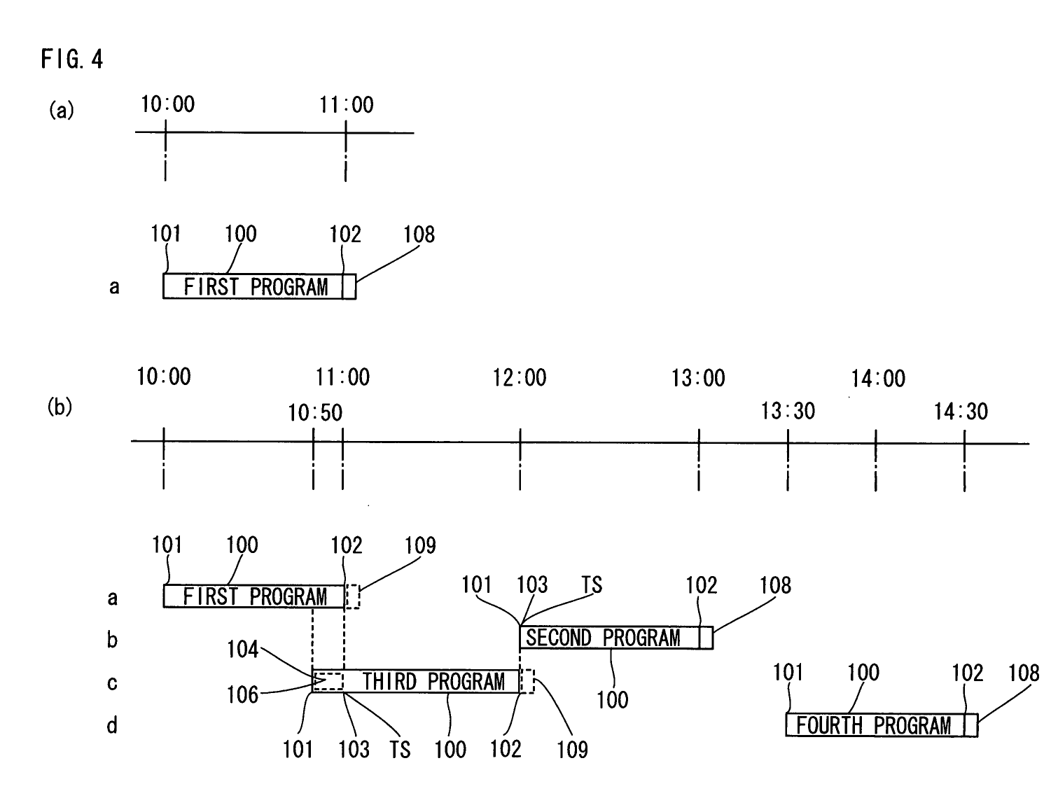

Next, FIG. 4 are time chart schematic diagrams showing preset recording program examples according to the present invention. FIG. 4 (a) shows the case where there is only one preset recording program, and FIG. 4 (b) shows a state in which multiple preset recording programs are overlapping during the recording time.

The preset recording program 100 shown in FIG. 4 (a) is the first program having the programmed recording set up first, where the recording starting time 101 is 10:00 and the recording ending time 102 is 11:00, thus set up as the programmed recording of 60 minutes. The first program does not overlap because there is no other preset recording program set up. To put it further in detail, the time for the recording end process portion 108 is added after the end of the recording at 11:00, and the recording end process 108 is performed at the recording ending time 102 of the first program because there is no other overlapping recording program.

Next, FIG. 4 (b) shows a state in which multiple preset recording programs 100 are sequentially set up after setting up the first program. As for the order of the recording starting time, the recording starting time 101 of the third program which is set up for recording thirdly following the first program having finished the setting first and is the second in recording order is set to 10:50 and the recording ending time 102 thereof is set to 12:00. Furthermore, the second program which is set up for recording secondly and is the third in recording order is set to 12:00 to 13:00, and the recording starting time 101 of the fourth program lastly set up is set 13:30 and the recording ending time 102 thereof is set to 14:30. To represent them in order of the recording starting time, they are the first program, third program, second program and fourth program. In FIG. 4 (b), however, they are represented in order of presetting, that is, the first program, second program, third program and fourth program.

As for the first and third programs having the overlapping recording time in FIG. 4 (b), the recording starting time 101 of the third program is set up without waiting for the recording ending time 102 of the first program. Thus, the 10 minutes from 10:50 as the recording starting time 101 of the third program to 11:00 as the recording ending time 102 of the first program becomes the program overlapping portion 104. As for the third program, the 10 minutes from 10:50 as the recording starting time 101 becomes an unrecordable portion 106. FIG. 3 (b) shows the stage of presetting, where the recording end process of the dashed portion 109 is not performed or is put off to omit the recording end process of the preceding first program and perform it together with the end process of the second program continuously following the first program in the overlapping preset recording program 100 according to the present invention. The recording ending time 102 of the first program has the portion 109 having the recording end process taking approximately 10 to 20 seconds put off indicated in the dashed line.

Next, the third program and second program will be described. The second program is to start the recording at 12:00 simultaneously with the end of the third program at 12:00 so that there is seemingly no program overlapping portion 104. As previously described, however, the program overlapping portion 104 is indicated in the dashed line as the dashed portion 109 not performed or put off to omit the recording end process of the preceding third program and perform the recording end process from the recording ending time 102 of the following second program in the overlapping preset recording program 100. The put-off recording end process portion 109 is approximately 10 to 20 seconds, which has been an unrecordable portion according to a conventional technology.

The second program and fourth program will be described based on the recording order. The recording ending time 102 of the second program is 13:00, and the recording starting time 101 of the fourth program is 13:30. Even if the recording end process time of approximately 10 to 20 seconds is added to the recording ending time 102 of the second program, it does not overlap the recording starting time 101 of the fourth program. Therefore, the recording ending time 102 of the second program has the recording end process portion 108 added thereto as the time for performing the recording end process by collectively handling the recordings of the first program, second program and third program as one recording file or collectively performing the recording end process including the recording end process put off in the aforementioned first program and third program. As for the recording ending time 102 of the fourth program, no other preset recording program is set up, and so the recording end process portion 108 performs the recording end process of the fourth program.

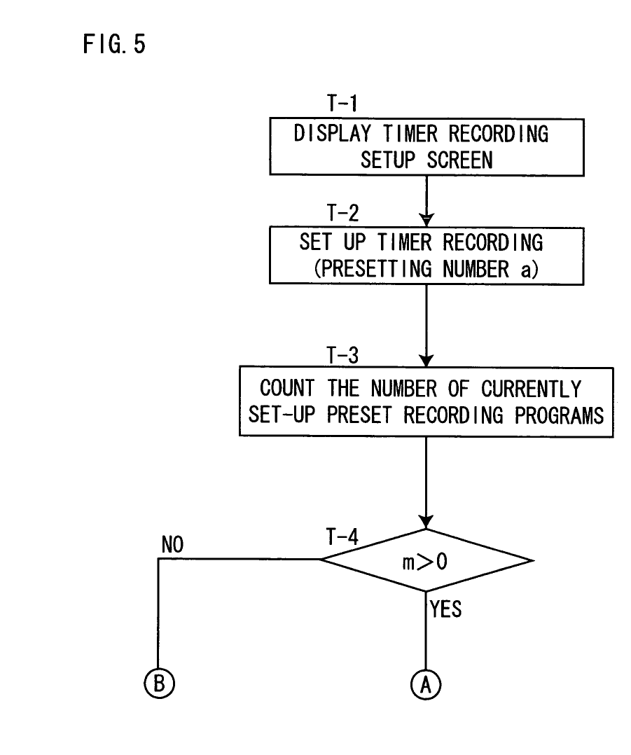

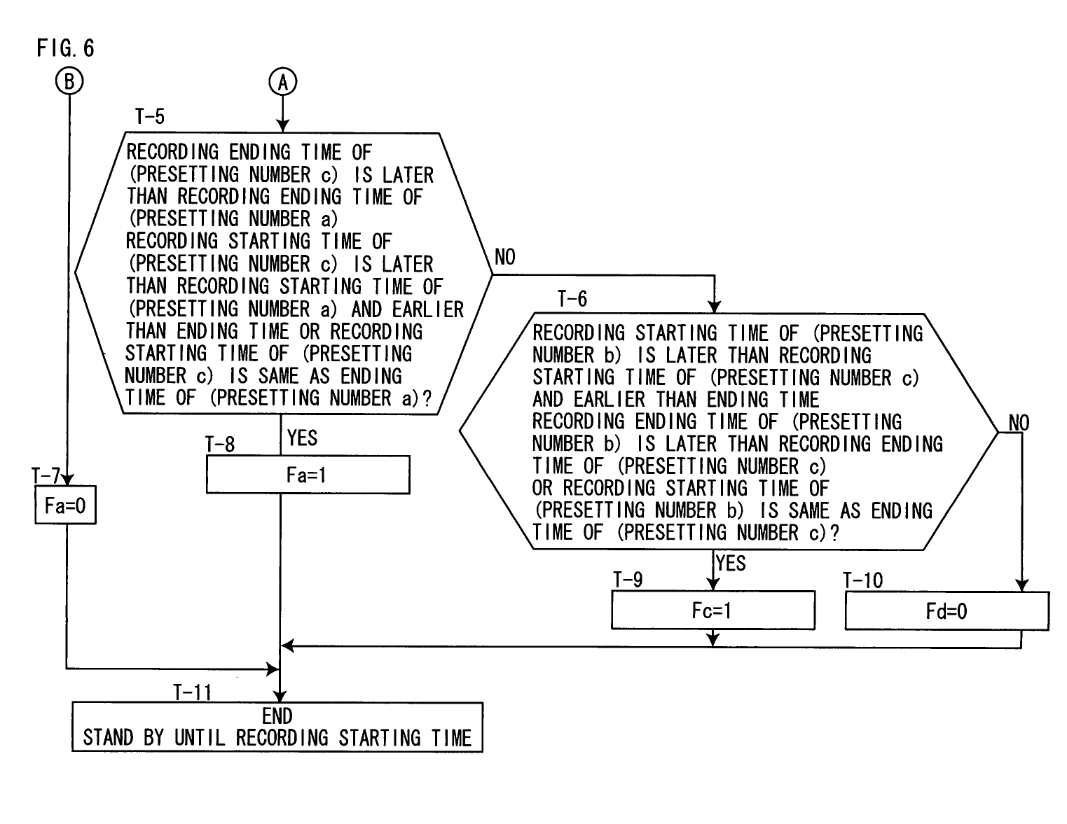

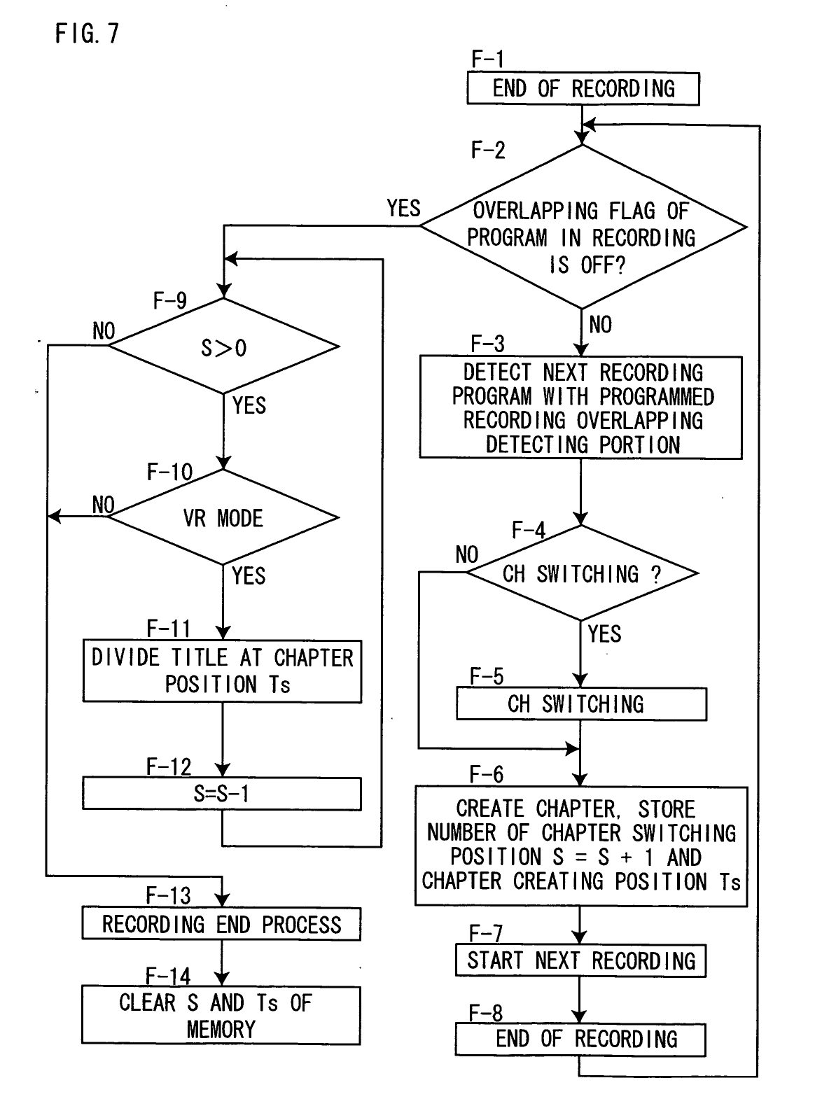

FIGS. 5 and 6 are flow chart schematic diagrams showing the operation on setting timer recording according to the present invention, and FIG. 7 is a flow chart schematic diagram showing the operation at the end of the timer recording.

In the FIG. 5, if an instruction to start the timer programmed recording is provided by an operation of the remote control 90 shown at T-1 of FIG. 1, an unshown menu screen for setting the timer programmed recording is displayed on the display portion 11 of the television set 10 by the presetting portion 62 shown in FIG. 1. Subsequently, the user performs the setup by selecting from the menu screen the recording starting time, ending time, recording channel, recording medium, recording mode and so on displayed on the menu screen with the unshown operation key of the remote control 90. As for the preset recording program which is set up, the presetting portion 62 provides presetting numbers indicated at T-2 of FIG. 5 such as a, b, c and d to the first to fourth programs shown in FIG. 4 (b) in presetting order so as to be stored in the first memory portion 68 in the microcomputer portion 60 shown in FIG. 1.

Next, the preset recording program having the presetting number provided thereto will be described by making a comparison with the time chart of the preset recording program shown in the aforementioned FIG. 4. As for the preset recording program 100 of the presetting number a provided to the first program shown in FIG. 4 (a), it is set as the programmed recording of 60 minutes with the recording starting time 101 at 10:00 and the recording ending time 102 at 11:00. As no other preset recording program 100 is setup, the first program of the presetting number a counts the number of programs of T-3 by means of the programmed recording overlapping detecting portion 63 shown in FIG. 1. As there is no other set-up preset recording program, it moves on to T-11 determining that there is no overlap because of m=0 at T-4. An overlapping flag Fa of the presetting number a becomes Fa=0 while remaining at an initial value 0.

Next, as in FIG. 4 (b), after the first program given the presetting number a is set up by the presetting portion 62 shown in FIG. 1, the presetting number b is set up by performing the programmed recording of the second program and multiple programs are subsequently set up as the preset recording programs in order such as the presetting numbers c and d, and then the number of the set-up preset recording programs m is counted and stored in the memory on setting up a new programmed recording at T-3 shown in FIG. 5. As for the number of the set-up preset recording programs m at T-4, if “YES” as to m>0, it determines that there are already multiple preset recording programs and moves on to T-5 shown in FIG. 6 to detect the overlaps thereof. If “NO” as to m>0, it determines that there is one preset recording program which is currently set up and moves on to T-11 so as to stand by until the recording starting time after finishing the presetting setup. Each time the preset recording program is set up at T-5 shown in FIG. 6, the programmed recording overlapping detecting portion 63 shown in FIG. 1 detects whether or not the recording time of the set-up preset recording program and the preset recording program for having its programmed recording newly set up is overlapping. Of the overlapping preset recording programs, the presetting number of the preset recording program to be recorded earlier is extracted and is determined as “YES” at T-5 or T-6 depending on the overlapping position shown in FIG. 6 so as to have each overlapping flag on. Furthermore, there are the cases where multiple overlapping portions exist in one preset recording program, and so the overlapping number counting portion 64 calculates the number of program overlaps n of the preset recording programs given the overlapping flags. A formula for this is n=(n)+α, where (n) indicates the number of the program overlaps in the stage prior to performing the programmed recording and α indicates the number of the overlaps increased by newly setting the programmed recording. In FIG. 4 (a), there is no preset recording programs in the stage of performing the programmed recording of the first program of the presetting number a, resulting in the number of the program overlaps of the preset recording programs=0. Even if the programmed recording of the first program of the presetting number a is set therein, it is n=(0)+0=0. In FIG. 4 (b), the first program of the presetting number a and the third program of the presetting number c are overlapping, and the third program of the presetting number c and the second program of the presetting number b are overlapping. However, the second program of the presetting number b and the fourth program of the presetting number d are not overlapping. Therefore, as the overlapping flag is given to the preceding preset recording program among the overlapping preset recording programs, the first program of the presetting number a and the third program of the presetting number c are in a state of having the overlapping flag on and the number of the program overlaps n of the preset recording programs in this state is n=(n)+α=0+2=2. The number of the overlaps is mainly calculated in the second embodiment. As for the second program of the presetting number b and the fourth program of the presetting number d, no preset recording program to be subsequently recorded at the end of the recording is detected by the programmed recording overlapping detecting portion 63. The second and fourth programs are determined as “NO” both at T-5 and T-6 shown in FIG. 6, and the given overlapping flags are Fb=0 and Fd=0 which are 0 of OFF as the initial value. The set-up preset recording programs and the preset recording programs just set up are compared one by one, and a setting process of the timer programmed recording is finished as shown at T-11 if the comparison with and detection from all the set-up preset recording programs are finished so as to stand by until the recording starting time of the set-up preset recording programs.

As for the first program of the presetting number a and the third program of the presetting number c of which recording time is overlapping among the multiple preset recording programs set up in FIG. 4 (b), the overlapping portions are checked and the preset recording program number to be given the overlapping flag ON/OFF is decided at T-5 shown in FIG. 6. And in the case where the already set-up preceding preset recording program precedes and the newly set-up preset recording program follows, the overlapping positions as to how the preset recording programs and end process time are overlapping are checked as follows depending on whether the recording time is overlapping or the recording starting time and the recording ending time are simultaneous. First, it is “YES” if the recording ending time of the follow-on newly set-up preset recording program is later than the recording ending time of the already set-up preceding preset recording program, and the recording starting time of the follow-on newly set-up preset recording program is later than the recording starting time of the already set-up preceding preset recording program and earlier than the ending time thereof. It is “NO” if one of them is not applicable. It is “YES” if the recording ending time and the recording starting time are the same time. It is “NO” if not the same time. If any one of them is “YES,” the overlapping flag of the already set-up preceding preset recording program is rendered as ON (1) at T-8. If all are “NO,” it is determined at T-6.

The first program of the presetting number a and the third program of the presetting number c are determined as follows based on the T-5. The first program of the presetting number a is the already set-up preset recording program to be recorded earlier, where the recording ending time of the follow-on third program of the presetting number c is later than the recording ending time of the first program and the starting time of the third program of the presetting number c is later than the starting time of the first program of the presetting number a and earlier than the ending time thereof. Therefore, it is determined as “YES” and the overlapping flag Fa of the already set-up preceding preset recording program becomes ON (1) at T-8. As the third program of the presetting number c starts the recording earlier than the follow-on second program of the presetting number b, it is determined as “NO” at T-5 to be left up to the determination at T-6.

When determined as “NO” at the T-5, if the recording of the newly set-up preset recording program precedes and the recording of the already set-up preset recording program follows, the overlapping positions as to how the preset recording programs and the end process time are overlapping are checked as follows depending on whether the recording time is overlapping or the recording ending time and the starting time are simultaneous. First, it is “YES” if the recording ending time of the follow-on already set-up preset recording program is later than the recording ending time of the newly set-up preceding preset recording program, and the recording starting time of the follow-on already set-up preset recording program is later than the recording starting time of the newly set-up preceding preset recording program and earlier than the ending time thereof. It is “NO” if one of them is not applicable. It is “YES” if the recording ending time and the recording starting time are the same time. It is “NO” if not the same time. If any one of them is “YES,” the overlapping flag of the newly set-up preset recording program is rendered as ON (1) at T-9. If all are “NO,” a new overlapping flag becomes OFF (0) at T-10.

The third program of the presetting number c is determined as follows at the T-6. The third program of the presetting number c is a new preset recording program to be recorded earlier than the second program of the presetting number b which is the already set-up preset recording program. As the recording ending time of the third program of the presetting number c and the starting time of the follow-on second program of the presetting number b are the same time, it is determined as “YES” resulting in an overlapping flag Fc of the third program of the presetting number c=ON (1) at T-9. If the fourth program of the presetting number d not overlapping any other program is checked here, the fourth program becomes “NO” at T-5 and T-6 resulting in an overlapping flag Fd=OFF (0) at T-10 subject to no overlapping.

At T-11 shown in FIG. 6, it stands by until the starting time to which the programmed recording is set. However, it is put in a programmed recording standby state after comparing the preset recording program just set-up with all the already set-up preset recording programs.

Next, the stage of recording the timer-programmed multiple preset recording programs will be described. If the first program of the presetting number a of FIG. 4 (b) starts the recording at 10:00, the overlapping flag put on by the programmed recording overlapping detecting portion 63 on setting the preset recording programs and the number of the overlapping portions counted by the overlapping number counting portion 64 are read from the memory and determined. The timekeeping portion 66 shown in FIG. 1 monitors the current time and recording time, and the recording execution control portion 67 shown in FIG. 1 switches to the recording mode and recording channel of the follow-on preset recording programs to continue the recording while continuing the recording from the ending first program without stopping it as the overlapping preset recording program of which follow-on preset recording programs should be successively executed at the end of the recording of the first program at 11:00. Thus, no recording end process is performed after the end of the first program, and the recording of the follow-on third program of the presetting number c is started without a break. In the case where the recording of the third program is that of a different channel from the first program, the recording is performed by immediately switching the channel, and the marking process portion 65 shown in FIG. 1 marks a starting position Ts of the third program, and records both the marked position and number of markings S=(S)+1=0+1=1 in the second memory portion 70 or on the recording medium 50 shown in FIG. 1. The (S) in this case denotes the number of markings in the stage before the marking is performed.

Next, a description will be given as to a method of writing recording data for recording the preset recording program. According to this embodiment, it is a writing method in the units of a cell wherein the recording data is pooled in a buffer from the recording starting position and a predetermined amount of the pooled data is written as one cell equivalent to the DVD recording medium 50 at any time. Apart from this, the method of writing the recording data to the DVD recording medium in real time is also possible.

As previously described, on finishing the recording of the first program of the presetting number a shown in FIG. 4 (b) wherein the programmed recordings of the overlapping preset recording programs are successively performed in advance at F-1 of FIG. 7, it is checked at F-2 whether or not the overlapping flag of the program engaged in recording is “OFF.” As there is the follow-on third program of the presetting number c as “NO” in FIG. 4 (b), a next third program is detected by the programmed recording overlapping detecting portion at F-3, and it is checked at F-4 whether or not the third program is a different channel. If a different channel, the channel is switched at F-5. Next, it is possible, by specifying as a recording switching position the recording starting position Ts of the third program following the marked first program controlled by the recording execution control portion 67, to create a chapter capable of instantaneously calling the recording switching position which is the recording starting position Ts of the specified number of markings S at F-6 after the end of the overlapping recording. In the case of writing in the units of a cell, the recording data of the first program pooled in the buffer at this point in time is written to the recording medium 50. Subsequently, the chapter is switched and the recording of the follow-on third program is started at F-7. In this case, the Ts as a recording starting point after switching the chapter, that is, the starting position of the third program is stored by the second memory portion 70 in order to create VTSI (Video Title Set Information) which is navigation data described later at the end of the recording of the three overlapping preset recording programs 100. Subsequently, it returns to F-2 at the end of the third program at F-8, and it is checked whether or not the overlapping flag of the third program engaged in recording is “OFF.” The follow-on second program of the presetting number b is detected at F-3, and the operations of F-4 to F-8 are performed as previously described so as to return to F-2. At the end of the recording of the three overlapping preset recording programs of the first program, second program and third program, the recording end process is performed under control of the recording execution control portion 67 shown in FIG. 1.

An overview of performing the recording end process will be described. A recording starting position Ts-1 of the marked third program and the starting position Ts of the follow-on second program are specified as the recording switching positions so as to create the chapter capable of instantaneously calling the recording switching position which is the recording starting position Ts of the specified number of markings S after the end of the overlapping recording. It is written to the VTSI holding title information on the DVD recording medium based on a video format in a DVD video format by referring to the recording starting position Ts after switching the chapter stored in the second memory portion 70. Similarly, in the case of a VR format apart from the video format, the recording starting position Ts of the preset recording program at which the recording started after switching the chapter is stored, and management information is written to a VR MANGR. IFO file on the recording medium 50 on which an LLA (Linking Loss Area) and a Border Out are created in an overrun protection area in the back of the recording data so as to write the extent of the recording data and finish the recording end process. To prevent an overrun of an unshown pickup provided to the DVD device for reading and writing the recording data from and to the recording medium 50 shown in FIG. 1, the LLA (Linking Loss Area) and Border Out are created in the overrun protection area in the back of the recording data so as to write the extent of the recording data. As for the recording switching position, it is possible to use a method of specifying the position by title division instead of the chapter. As there is no continuous and following preset recording program at the end of the second program of the presetting number b, it is “YES” as to the check of whether or not the overlapping flag is “OFF” at F-2, and it is checked whether or not the number of markings S is S>0 at F-9. Here, the recording starting positions of the third program and the second program are marked so far, and it is “YES” because of the number of markings S=2 so that it is checked whether or not the VR mode at F-10. If the VR mode, it is “YES” and the title division is performed at a chapter switching point at F-11, and it becomes the number of markings S=2−1=1. It subsequently returns to F-9 to check whether or not S>0. It is “YES” because of the S=1, and is checked at F-10. If the VR mode at F-11, the title division of the second program is performed and it becomes S=1−1=0 at F-12. On returning to F-9, it is already S=0 against S>0 and so it is “NO” so that the recording end process is performed at F-13 and the S and Ts stored in the second memory portion 70 shown in FIG. 1 are erased and become clear at F-14.

### Second Embodiment

A second embodiment of the timer recording of the present invention will be described by referring to FIGS. 8 and 9.

FIG. 8 shows the second embodiment showing the operation in the process on setting up the timer programmed recording. At S-1, upon an instruction to start setting up the timer programmed recording from the remote control 90 shown in FIG. 1, the unshown menu screen for setting the programmed recording is displayed on the display portion 11 of the television set 10 by the presetting portion 62 shown in FIG. 1. Subsequently, at S-2, the user performs the setup by selecting from the menu screen the recording starting time, ending time, recording channel, recording medium, recording mode and so on displayed on the menu screen by operating the remote control 90. The first program shown in FIG. 4 (b) of which recording starting time is 10:00 and recording ending time is 11:00 is already set up as the preset recording program. At S-3, the number of the set-up preset recording programs is checked by the presetting portion 62 shown in FIG. 1, and it is “YES” if the number of the preset recording programs is one. The number of overlapping programs is determined as n=0 at S-4, and the setting of the timer programmed recording is finished at S-7. Subsequently, the programmed recording is set up for the second program of which recording starting time is 12:00 and recording ending time is 13:00, and it is checked whether or not the number of the preset recording programs set up at the S-3 is one. As a result of having the second program additionally set up, the number of the preset recording programs becomes two and it becomes “NO.” And then, at S-5, the programmed recording overlapping detecting portion 63 shown in FIG. 1 determines whether or not the recording starting time of the second program additionally set up is within and overlapping the recording time of the already set-up first program, whether or not the starting time of the first program is within the recording time of the second program or whether or not the starting time of one of the preset recording program is the same time as the ending time of the other preset recording program. As the second program is not overlapping the first program, it becomes “NO” and the setting of the timer programmed recording is finished at S-7. If the programmed recording of the third program shown in FIG. 4 (b) is performed thereafter, it is checked again whether or not the number of the preset recording programs set up at the S-3 is one. As a result of having the third program additionally set up, the number of the preset recording programs becomes three and it becomes “NO.” And then, at S-5, the programmed recording overlapping detecting portion 63 shown in FIG. 1 determines whether or not the recording time of the third program additionally set up is within and overlapping the recording time of the already set-up first program and the second program. The checking method of S-5 of FIG. 8 gives a simplified description of performing the same checking operations as T-5 and T-6 of FIG. 6, where a comparison is made between the recording starting time and the recording ending time and vice versa as to each of the multiple preset recording programs so as to check whether or not overlapping. Here, it is determined that the recording starting time of the third program is overlapping the first program and the recording ending time of the third program is overlapping the second program so that it is “YES.” Next, as for the number of the overlapping preset recording programs at S-6, it is n=(0)+1=1 by the formula of n=(n)+α in the case where two preset recording programs are overlapping at one location, and it is n=(1)+1=2 in the case where three preset recording programs are overlapping at two locations. It is determined that the three preset recording programs are overlapping at two locations so as to be stored in the second memory portion 70 shown in FIG. 1 and stand by until the recording starting time at S-7.

FIG. 9 shows the second embodiment showing the operation in the process at the end of the timer programmed recording. In the case where the first program to the third program are set up in FIG. 4 (b), the programmed recording is performed in recording starting order of recording the first program and the third program next and then recording the second program. At the end of the recording E-1 of the first program, the recording execution control portion 67 shown in FIG. 1 checks, by a determination formula of n>0, whether or not the number of the locations at which the preset recording programs are mutually overlapping is 0 or more as to all the preset recording programs at E-2. The recording of the first program is overlapping the recording starting time of the third program, and the recording ending time of the third program is overlapping the recording starting time of the second program so that it is n=2 and “YES.” At E-3, the programmed recording overlapping detecting portion 63 shown in FIG. 1 determines whether or not the current time is within recording setup time of the follow-on third program based on a comparison and a check of current time information and timer preset time of the timekeeping portion 66. As the recording ending time of the first program is overlapping the third program as previously described, it is determined as “YES.” It is subsequently determined at E-4 whether or not it is necessary to switch the channel. The third program is overlapping because the preset recording program starting time of a program of another channel is set up before the end of the recording of the first program. Therefore, it requires the channel switching and becomes “YES” so that the channel switching indicated at E-5 is performed under control of the recording execution control portion 67 shown in FIG. 1.

Subsequently, at E-6, the chapter is created and the switching position of the preset recording program is recorded. At this point in time, the marking process portion marks a recording starting position T of the follow-on third program in the stage at the end of the first program and records it with the number of markings S=1 both in the second memory portion 70 and/or on the recording medium 50. Next, the number of overlaps of the preset recording program is calculated. While it is n=2 at S-6 shown in FIG. 8, it is n=(2)−1=1 according to the formula of n=(n)−1 of E-7 and is recorded in the second memory portion 70 shown in FIG. 1. On starting the programmed recording, the recording is started by reading the data on the overlapping flag and the number of overlaps n stored in the second memory portion 70 when setting up the programmed recording. In the case where the overlapping flag is on, no recording end process is performed when the first program execution comes to the recording ending time and switches to the recording of the overlapping third program. The number of overlaps with the program is determined from the number of overlaps n read from the second memory portion 70 on starting the recording so as to start the recording of the follow-on third program without a break. At E-8, the recording of the follow-on third program is started. When the recording of the third program is subsequently finished at E-9, it returns to E-2 and repeats the recording of the second program switched simultaneously with the recording ending time of the third program up to E-9 so as to successively repeat E-2 to E-9 until there is no follow-on preset recording program.

If the number of the overlapping preset recording programs becomes 0 and it is determined as “NO” at E-2 or there is no follow-on preset recording program and it is determined as “NO” at E-3, it is determined whether or not the number of markings S of the preset recording program having finished the recording is S>0 at E-10. If S=1 and “YES,” it is subsequently determined whether or not it is the VR mode at E-11. If “YES,” the title is divided on switching the recording program at E-12. When in the VR mode, it is thus possible to create the title at the end of the recording. Subsequently, at E-13, a marking point process is finished as to the preset recording program having finished the recording and having the title created, and so it is S=S−1. And if there is no other recording program having undergone no marking point process at E-10, it is determined as “NO” and finished at E-14. If determined as no VR mode and determined as “NO” at E-11, the recording is finished at E-14. If the current time is not overlapping the recording setup time of another preset recording program at E-3, it is determined as “NO” and the title is created and a record is made at E-10 to E-14 so as to finish the programmed recording operation.

As described above, according to this embodiment, the television set 10 having the built-in DVD recording and reproducing device as the electronic device including the timer programmed recording means of the present invention comprises the tuner 30 for converting a receiving signal of a television broadcast to a video and audio signal, the video and audio processing portion 40 for converting the video and audio signal to a recordable digital video and audio signal, the microcomputer portion 60 for controlling the video and audio processing portion 40 and also controlling a timer programmed recording operation, the first memory portion 68 in the microcomputer portion 60 for storing a preset recording program of the microcomputer portion 60, the second memory portion 70 for storing control information on the preset recording program and the recording medium 50 for recording and making a record of the digital video and audio signal. The television set 10 having the built-in DVD recording and reproducing device further includes therein the remote control 90 for transmitting an instruction of the user to the microcomputer portion 60 and the remote control light receiving portion 80 for light-receiving an instruction signal inputted by a key operation of the remote control 90 so as to perform recording on the recording medium 50, wherein the key input processing portion 61 included in the microcomputer portion 60 processes the instruction signal light-received from the remote control 90, the presetting portion 62 sets the key-inputted preset recording programs 100, the programmed recording overlapping detecting portion 63 detects and determines whether or not the recording time is overlapping as to the multiple preset recording programs 100, the overlapping number counting portion 64 counts the number n of overlapping portions 104 of the preset recording programs 100 or the number of overlapping preset recording programs, the timekeeping portion 66 including a clock circuit monitors the current time and at least the recording starting time 101, recording ending time 102, overlapping starting time 101 and overlapping ending time 103 of the preset recording program 100, the marking process portion 65 marks the follow-on recording starting position T as the switching time of the preset recording programs 100 overlapping correspondingly to the overlapping flag F, and the recording execution control portion 67 stores the preset recording programs 100 in the first memory portion 68 in the microcomputer portion 60, stores the overlapping flag, the number of overlaps and the marking as the control information on the preset recording program in the second memory portion 70, and the recording execution control portion 67 exerts execution control of the preset recording programs 100 based on time information of the timekeeping portion 66. Even if the multiple preset recording programs 100 come to overlap by switching the recording with the marked position T as the switching position T of the overlapping programs, the recording execution control portion 67 can exert control so as to perform no recording end process 109 of the preceding preset recording program 100 at the end of the recording of the preceding preset recording program 100 among the overlapping preset recording programs 100, start recording by successively switching to the follow-on preset recording programs 100 at the marked position and perform the recording end process 108 of the multiple overlapping preset recording programs at the recording ending time 102 of the last one of the follow-on overlapping preset recording programs 100. It is possible to execute or put off the process time of the recording end process 109 required on switching the overlapping preset recording program 100 at the end of the recording of the follow-on preset recording programs 100. It is also possible, even if the overlapping portions of the recording time are generated successively at multiple portions, to switch to the follow-on new program promptly and start the recording so as to resolve the time missing the recording due to the recording end process 109 required on switching the programs. Therefore, it is possible to prevent an equivalent to the time required for the recording end process 109 from missing from the recording starting time 101 of the follow-on preset recording program 100 onward.

Furthermore, as for the overlapping preset recording programs 100, the recording end process time 109 is added to the required time for the preset recording programs 100 so that the recording time overlaps. Thus, even in the case where the recording ending time 102 and recording starting time 101 of the multiple preset recording programs 100 seemingly continuously switchable become simultaneous, it has been conventionally necessary to perform the recording end process 109 at the recording ending time 102 of each individual preset recording program 100 so that there has been the problem that the recording starting portion of the follow-on preset recording program 100 becomes missing. It is possible, in this regard, to put off the recording end process 109 and perform the recording end process 108 collectively at the recording ending time 102 of the last preset recording program 100 which is no longer overlapping. Therefore, even if there is a portion of overlapping recording time on performing multiple programmed recordings on the electronic device such as a DVD recording device, a DVD recording and reproducing device or a television set having them built-in, it is possible to start the recording by promptly switching to the follow-on new program and thereby resolve the cases of missing the recording due to the recording end process 108 required on switching the program and also allow the recording channel to be smoothly switched without interruption of the recording so as to reduce the discomfort of the user. Therefore, it is possible to avoid the problem that, if the preset recording program 100 following the preceding preset recording program 100 is a PPV which is a pay-broadcast for instance, the preset recording program 100 as the PPV cannot be started when the starting time 101 of the programmed recording is delayed just by 10 to 20 seconds from the preset time.

The embodiments were described as above. However, the present invention is not limited thereto but various deformed embodiments are possible within the scope of the present invention. For instance, the electronic device capable of recording or recording and reproducing the multiple preset recording programs is not limited to the electronic device such as the television set 10 having the built-in DVD device with the recording function or DVD recording and reproducing device. It may also be the device capable of digital recording such as an HDD device. Functional divisions in the microcomputer portion 60 such as the programmed recording overlapping detecting portion 63, overlapping number counting portion 64 and marking process portion 65 are not limited to the embodiments but may be selected as appropriate, and may be changed in view of the configuration of the microcomputer portion 60 in consideration of easiness of design and usability in the state capable of exploiting the necessary functions.

According to the first aspect of the present invention, the electronic device including timer programmed recording means for performing recording on a recording medium comprises a tuner for converting a receiving signal of a television broadcast to a video and audio signal, a video and audio processing portion for converting the video and audio signal to a recordable digital video and audio signal, a microcomputer portion for controlling the video and audio processing portion and also controlling a timer programmed recording operation; a first memory portion in the microcomputer portion for storing a preset recording program information of the microcomputer portion, a second memory portion for storing control information on the preset recording program, and the recording medium for recording and making a record of the digital video and audio signal, and further comprises a remote control for transmitting an instruction of a user to the microcomputer portion, and a remote control light receiving portion for light-receiving an instruction signal inputted by a key operation of the remote control. The microcomputer portion is provided therein with a key input processing portion which processes the instruction signal light-received from the remote control, a presetting portion which sets a key-inputted preset recording program, a programmed recording overlapping detecting portion which detects and determines whether or not recording time is overlapping as to multiple preset recording programs and provides an overlapping flag thereafter, and the overlapping number counting portion which counts the number of overlapping portions of the preset recording program. The timekeeping portion including a clock circuit monitors a current time and at least a recording starting time, a recording ending time, an overlapping starting time and an overlapping ending time of the preset recording program, the marking process portion marks a switching time of the overlapping preset recording program, and the recording execution control portion stores the preset recording program in the first memory portion in the microcomputer portion, stores the overlapping flag, the number of overlaps and the marking as the control information on the preset recording program in the second memory portion and exerts execution control of the preset recording program based on time information of the timekeeping portion. Thus, even if the multiple preset recording programs come to overlap, the recording execution control portion can exert control to perform no recording end process of the preset recording program at the end of the preset recording program preceding in recording among the overlapping preset recording programs, start recording by successively switching to the follow-on preset recording programs at the marked position and perform the recording end process of the multiple overlapping preset recording programs at the end of recording of the last one of the follow-on overlapping preset recording programs. Therefore, it is possible to perform the recording end process required on switching the overlapping preset recording programs at the end of the recording of the follow-on preset recording programs or put it off so as to prevent the portion of the recording end process time from missing as from the recording starting time of the follow-on preset recording program. For this reason, even if there is a portion of overlapping recording time on performing multiple programmed recordings on the electronic device such as a DVD recording device, a DVD recording and reproducing device or a television set having them built-in, it is possible to start recording by promptly switching to a follow-on new program and resolve the cases of missing the recording of a new program due to the recording end process before switching. Therefore, it is possible to avoid the problem that, if the preset recording program following the preceding preset recording program is a PPV which is a pay-broadcast, the preset recording program as the PPV cannot be started when the starting time of the programmed recording is delayed just by 10 to 20 seconds from a preset time.

According to the second aspect of the present invention, the overlapping preset recording program has the recording time overlapped by adding the recording end process time to the time required for the preset recording program. Conventionally, there is a problem that, even in the case where the recording starting time and recording ending time of the multiple preset recording programs looking successively switchable at a glance become simultaneous, it is necessary to perform the recording end process at the end of recording of each individual preset recording program so that a recording starting portion of the follow-on preset recording program becomes missing. It is possible, in this regard, to put off the recording end process and perform it collectively at the end of recording of the last preset recording program which is no longer overlapping. Therefore, even if there is a portion of overlapping recording time on performing multiple programmed recordings on the electronic device such as a DVD recording device, a DVD recording and reproducing device or a television set having them built-in, it is possible to start recording by promptly switching to a follow-on new program and resolve the cases of missing the recording of the new program due to the recording end process before the switching. Therefore, it is possible to avoid the problem that, if the preset recording program following the preceding preset recording program is a PPV which is a pay-broadcast for instance, the preset recording program as the PPV cannot be started when the starting time of the programmed recording is delayed just by 10 to 20 seconds from a preset time.

What is claimed is:

1. An electronic device including timer programmed recording means for performing recording on a recording medium, comprising:
a tuner for converting a receiving signal of a television broadcast to a video and audio signal;
a video and audio processing portion for converting the video and audio signal to a recordable digital video and audio signal;
a microcomputer portion for controlling the video and audio processing portion and also controlling a timer programmed recording operation;
a first memory portion in the microcomputer portion for storing a preset recording program of the microcomputer portion;
a second memory portion for storing control information on the preset recording program, and
the recording medium for recording and making a record of the digital video and audio signal, and further comprising:
a remote control for transmitting an instruction of a user to the microcomputer portion; and
a remote control light receiving portion for light-receiving an instruction signal inputted by a key operation of the remote control, and wherein:
the microcomputer portion includes:
a key input processing portion for processing the instruction signal light-received from the remote control;
a presetting portion for setting a key-inputted preset recording program;
a programmed recording overlapping detecting portion for detecting and determining whether or not recording time is overlapping as to multiple preset recording programs and providing an overlapping flag;
an overlapping number counting portion for counting the number of overlapping portions of the preset recording program;
a timekeeping portion, including a clock circuit, for monitoring a current time and at least a recording starting time, a recording ending time, an overlapping starting time and an overlapping ending time of the preset recording program;
a marking process portion for marking a switching time of the overlapping preset recording program correspondingly to the overlapping flag; and
a recording execution control portion for storing the preset recording program in the first memory portion in the microcomputer portion, storing the overlapping flag, the number of overlaps and the marking as the control information on the preset recording program in the second memory portion, and exerting execution control of the preset recording program based on time information of the timekeeping portion, and
the recording execution control portion exerts control so as to perform no recording end process of the preset recording program at the end of the preset recording program preceding in recording among the overlapping preset recording programs, start recording by successively switching to the follow-on preset recording programs at the marked position and perform the recording end process of the multiple overlapping preset recording programs at the end of recording of the last one of the follow-on overlapping preset recording programs.

2. The electronic device including timer programmed recording means according to claim 1, wherein the overlapping preset recording program includes overlapping recording time caused by adding the recording end process time to the time required for the preset recording program.
